(19) United States
(12) Patent Application Publication
(10) Pub. No.: US 2002/0054044 A1
(43) Pub. Date: May 9, 2002

(54) Collaborative screen sharing system

(76) Inventors: Lee-Chung Lu, Hsinchu (TW); Chin-Wen Lin, Hsinchu (TW); Yao-Chang Chang, Hsinchu (TW)

Correspondence Address: BACON & THOMAS, PLLC, 625 Slaters Lane, 4th Floor, Alexandria, VA, 22314-1176, US

(21) Appl. No.: 09/741,059

(22) Filed: Dec. 21, 2000

(30) Foreign Application Priority Data
Nov. 8, 2000 (TW) 89123646

(51) Int. Cl. G06F 13/00; G06F 12/02

(52) U.S. Cl. 345/536; 345/543

(57) ABSTRACT

This invention discloses a novel collaborative screen sharing system. In the invented method for collaborative screen sharing, updates to a previously displayed screen are transmitted from a local computer to a remote computer for display. At the local computer, the updates are divided into unit blocks circulated by rigid lines and compared with screen displays stored in the cache memory of the local computer and the remote computer. In transmitting the updates, only identities of unit blocks with screen display identical to screen displays previously stored are transmitted. For unit blocks with screen display not identical to any screen display previously stored, identities and screen display information of the unit blocks are transmitted. Images and unit blocks stored in the local computer and the remote computer are maintained identical and are updated simultaneously.

### FIELD OF THE INVENTION

The present invention relates to a collaborative screen sharing system, especially to a screen sharing system wherein screen display information may be transmitted through a network with efficiency.

### BACKGROUND OF THE INVENTION

Due to the wide application of the network communication technology, collaborative screen sharing has become an important application of the computer system. In order to share the screen display of a local computer, the screen display information needs to be transmitted through a communication network, such as the internet, to a remote computer and displayed on the screen of the remote computer. Many research and development have been done in this field, hoping that data to be transmitted in sharing the screen display may be reduced and that transmission time and bandwidth may be saved.

U.S. Pat. No. 5,491,780 (issued to Fyles et al.) pertains to a “System and method for efficient computer workstation screen updates”. In this invention, the screen display of a local computer is transmitted through a network to a remote computer for collaborative processing, whereby changes to the screen of the local computer may be reflected on the screen of the remote computer. According to Fyles et al., rather than having to transmit the whole contents of the screen, only those areas of the screen that have been modified are transmitted, resulting in much quicker updating of the remoter screens. In an embodiment of the Fyles et al. invention, each identified portion of the screen is represented by a rectangle, and it is then the contents of this rectangle that is transmitted to the other computer in the network.

Although the Fyles et al. invention provides an effective approach to reduce the quantity of data to be transmitted in sharing the updates of the screen display, a more effective method in sharing the screen display is still necessary.

### OBJECTIVES OF THE INVENTION

It is thus the objective of this invention to provide a novel collaborative screen sharing system.

Another objective of this invention is to provide a novel method for collaborative screen sharing between a local computer and a remote computer.

Another objective of this invention is to provide a novel method for collaborative screen sharing wherein data to be transmitted from a local computer to a remote computer may be reduced.

Another objective of this invention is to provide a method for collaborative screen sharing wherein unchanged images are redisplayed.

Another objective of this invention is to provide a method for collaborative screen sharing wherein most unchanged images may be allocated.

### SUMMARY OF THE INVENTION

According to the present invention, a novel method for screen sharing is provided. The present invention provides an improvement over the Fyles et al. invention by providing a unit block dividing and caching mechanism in the local computer and in each remote computer that shares the screen display of the local computer.

Under the present invention, screen displays of a local computer are divided into unit blocks and stored in the memory of the local computer. Identities and content of the unit blocks are then transmitted to a remote computer and stored in the memory of the remote computer. A screen display to be displayed in the local computer is first compared with a previous screen display. The differences between the screen display to be displayed and the previous screen display is then divided into unit blocks. Unit blocks of the differences are then compared with the stored unit blocks. Identities and content of unit blocks of the differences are transmitted to the remote computer and is stored in the memory of the remote computer, if no unit block with identical screen display is allocated in the memory of the local computer. Unit blocks of the differences are transmitted to the remote computer by sending “events” information representing these unit blocks, if unit blocks with respective identical screen displays are allocated in the memory of the local computer. The remote computer displays the screen displays of the transmitted unit blocks from its memory according to their identities. By sending these events instead of screen display information represented by the events, data to be transmitted upon updates of the screen display of the local computer may be greatly reduced in comparison to when the screen display information of the whole block as changed is transmitted. These and other objectives and advantages of this invention may be clearly understood from the detailed description by referring to the following drawings.

### BRIEF DESCRIPTION OF THE DRAWINGS

FIG. 1 illustrates the flow chart of an embodiment of the method for collaborative screen sharing of this invention.

FIG. 2 illustrates a screen display to be shared by a local computer and a remote computer.

FIG. 3 illustrates another screen display to be shared by a local computer and a remote computer.

FIG. 4 illustrates differences between the screen displays of FIG. 2 and FIG. 3.

### DETAILED DESCRIPTION OF THE INVENTION

The present invention discloses a method of collaborative screen sharing system with cache. Although it is not intended to limit the scope of this invention, according to this invention, a screen display displayed at a previous time may be redisplayed at a later time, although some portions of the screen display are changed at said later time. Take the graphic display of a standard Windows (a registered of Microsoft) environment for example. When the local computer is operated, often the screen display will include a repeated menu selection, a repeated dialog usage, a repeated icon highlight, a repeated hint showing, an animated imageand a web browsing forward and backward image. In displaying these images, it is only necessary to change the changed portions (updates to the previous screen) of the image and rest portions of the image may be redisplayed by referring to the image file stored in the cache or other memories.

Further according to this invention, in the above-mentioned types of repeated images, it is possible to allocate updated portions of an image by dividing the previous image into unit blocks and allocating blocks which contains updated portions. In other words, in displaying an image at a later time, unit blocks of the previous image which contained changes of image are updated while the rest blocks of the previous image are redisplayed. As a result, in updating the image, only the screen display information of the unit blocks need to be updated is transmitted and the replayed blocks are transmitted as events, in replacement of transmission of image data of these rest blocks. Transmission time and bandwidth may thus be successfully reduced.

According to this invention, screen display information is shared by a local computer and a remote computer. Updated information of the screen display may be transmitted from the local computer to the remote computer in the form of “events”. In this invention, the event to be transmitted in replacement of graphic information includes:

1. Redraw a block in cache at its original location,

2. Redraw a block in cache at screen location x, y, and

3. Redraw a portion of a block in cache at screen location x, y of size w, h.

In order to decide for a specific updated screen whether an event or a screen display shall be transmitted, the previous displayed screen display is divided into unit blocks and saved in the cache memory of the local computer and the remote computer. The screen display to be transmitted is compared with the previous screen display and updated information is found. Updates to the previous screen display is divided into unit blocks. Identities and screen display of these blocks are then transmitted to the remote computer. In this invention, for unit blocks with screen display identical to that of unit blocks already stored in the cache memory of the local computer and the remote computer, only identities representing these unit blocks are transmitted, without the need of transmitting screen display information of these blocks. Screen display information of these blocks is picked-up from the cache memory and redrawn in the desired screen locations.

By sending these events, data to be transmitted to update the screen display of the remote computer may be greatly reduced.

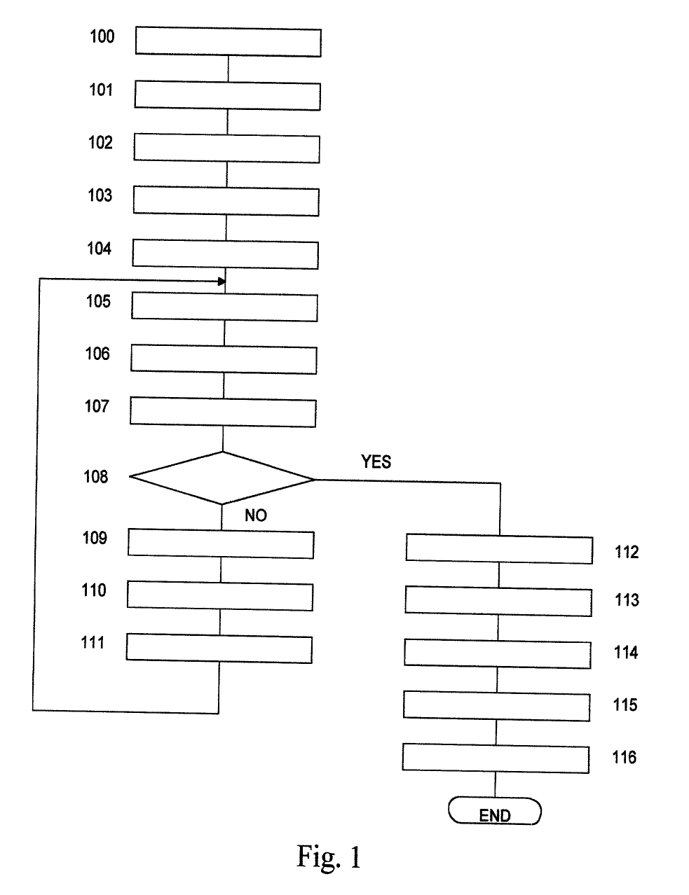

The following is a description of the embodiment of the collaborative screen sharing system of this invention. FIG. 1 illustrates the flow chart of an embodiment of the method for collaborative screen sharing of this invention.

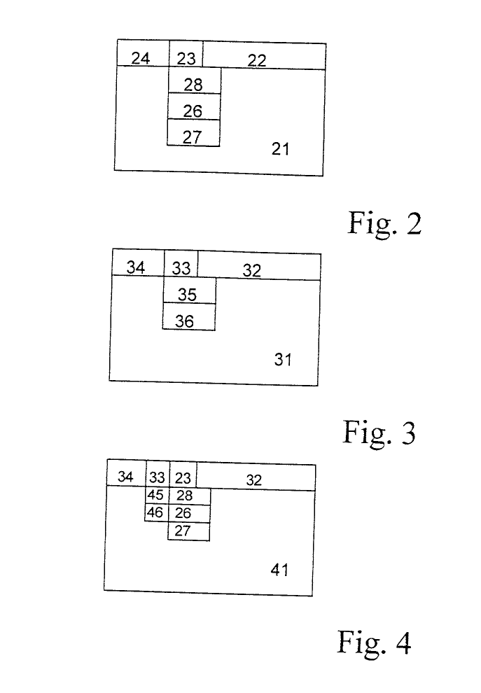

An example of switching from a first screen to a second and from the second to the first is taken to illustrate the invented screen sharing system. FIG. 2 shows a screen display of a first time point and a third time point and FIG. 3 shows a screen display of a second time point. When these screens are displayed on the screen of a local computer, at the first time point information contained in FIG. 2 is shown, at the second time point information contained in FIG. 3 is shown and at the third time point information contained in FIG. 2 is shown again. In order to share these screen displays with a remote computer, these screen displays are displayed on the screen of the remote computer under the same sequence. In the conventional art, at the first time point the information contained in FIG. 2 is transmitted to the remote computer, at the second and third time point the information of unit blocks containing updated screen displays is transmitted.

According to this invention, however, at the third time point only events representing updates (changes) to the information contained in FIG. 3 in comparison to the information contained in FIG. 2 are transmitted to the remote computer for display.

For the convenience of illustration, the screen display of FIGS. 2 and 3 are divided into blocks represented by numbers shown in these figures. FIG. 4 illustrates differences between screen displays of FIGS. 2 and 3. Here, the differences may be called “updates” or “changes” to the screen display of FIG. 3. Again, these updates are divided into blocks represented by numbers 41, 45 and 56 and 23, 25, 26, 27 and 28. In a graphic environment, blocks shown in FIG. 4 and represented by numbers 41, 23, 33 and 34 are often treated as backgrounds. In the following description of this invention, description to processing of these blocks will be omitted, since the method of screen sharing of this invention may be easily applied to such processing. To simplify the description, screen display represented by FIG. 3 will be called the “last screen” and that represented by FIG. 2 will be called the “current screen”.

As shown in FIG. 1, at 100 the information contained in FIG. 2 is displayed on the screen of a local computer. At 101, the screen display information is divided into blocks by the local computer and blocks 25, 26, 27 and 28 are obtained. These blocks may be called unit blocks and are stored in the cache memory of the local computer at 102. In step 101, blocks as divided are screen display information circulated by rigid borderlines in the display. Other method to define a unit block may also be used to divide the unit blocks. The block-division mechanism may be easily achieved according to any known art. The block-division mechanism as disclosed in the above-mentioned Fyles et al. invention may be taken for reference.

In dividing the updated into blocks, if an update block contains further block or blocks circulated by it, such as block 28 in FIG. 2, these smaller blocks are treated as unit blocks for processing and the containing block exclusive of the contained block(s) is treated as a unit block. Of course, other method to define a unit block may also be suited in this invention.

At 103 the screen display information of FIG. 2 is transmitted from the local computer to a remote computer for display. At 104 the transmitted screen display information is displayed in the screen of the remote computer and the blocks as well as their screen display information are stored in the cache memory of the remote computer for further use.

At 105 the local computer displays a next screen that is identical to that of FIG. 3. At 106 the local computer compares the next screen display with the current screen display, i.e., the screen display of FIG. 2, and differences between the two screen displays are obtained. At 107 the differences (updates) are divided into unit blocks in the similar way as described above and blocks 35 and 36 (“update blocks”) are obtained. At 108 the update blocks 35 and 36 are compared with all blocks as stored in the memory of the local computer. The result shows that no identical blocks exist in the memory of the local computer. As a result, the update blocks 35 and 36, along with their screen display information, are stored in the cache memory of the local computer at 109. At 110 unit blocks 35 and 36 and their screen display information are transmitted to the remote computer and, at 111, are displayed on the screen of the remote computer and stored in the cache memory of the remote computer. The system returns to step 105 to display a next screen.

When the local computer displays in a following time point the screen as shown in FIG. 2, at 106 the local computer compares the next screen display (FIG. 2) with the current screen display (FIG. 3) and differences between them are thus obtained. Step 107 is repeated and update blocks 45, 46 and 25-28 are obtained, as shown in FIG. 4.

The update blocks are compared with the unit blocks as stored in the cache memory of the local computer at 108, whereby blocks 25-28 are found identical to those blocks 25-28 already stored and blocks 45 and 46 are new. At 142, blocks 25-28 are retrieved from the cache memory of the local computer. At 113, blocks 45 and 46 and their screen display information are stored in the cache memory of the local computer and these blocks as well as blocks 25-28 are displayed on the screen of the local computer.

At 114, blocks 45 and 46 and their screen display information, as well as blocks 25-28, exclusive of their screen display information, are transmitted to the remote computer. At 115 blocks 45 and 46 and their screen display information are stored in the cache memory of the remote computer. At 116 the screen display information of blocks 45 and 46 as transmitted and the screen display information of blocks 25-28 as picked up from the cache memory of the remote computer are displayed on the screen of the remote computer. The operation returns to step 105 unless there is no other screen to be displayed.

As in this invention, when updates to a last screen contains unit blocks identical to those in a previously transmitted screen, only description of the unit blocks are transmitted. It is thus not necessary to transmit data representing screen display information of the updates of the current screen. Data to be transmitted in sharing the screen display is reduced. As the screen display information is divided into unit blocks, it is thus easier to allocate identical blocks from the previously transmitted information from the cache memory of the local computer and the remote computer.

According to a preferred embodiment of this invention, unit blocks with screen display partially identical to that of unit blocks previously stored are treated as identical unit blocks. With this approach, it is possible to allocate identical unit blocks in blocks 35 and 36 and, thus, only description of blocks 45 and 46, instead of their screen display information, is transmitted to the remote computer. As a result, data to be transmitted in sharing the screen display may be further reduced.

In transmitting the unit block description, each unit block may be represented by the description of UR(w, h, x, y) wherein w and h represent width and height of the unit block and x and y represent coordinate of the left-top corner of the unit block in the screen. In another embodiment of this invention, the unit blocks are represented by the description of CUR(ID, w, h, x, y) wherein w, h, x, and y have the above-said definition and ID represents a unique code of the unit block that is coded and stored in the cache memory of the local computer and the remote computer. By using the CUR coding system it is possible to transmit for a unit block at the identical position of display only the ID of the unit block. Under this coding system, the unit blocks may be displayed at any position on the screen and portioned display of a unit block is facilitated.

As cache memory is a limited resource of a computer device, it may be desirable to provide an updating mechanism for the cache memory such that scarcely used unit blocks may be deleted from the cache memory. As many updating technology in the known art may be applicable to this invention, detailed description thereof is thus omitted.

In the above description, the unit block information and the screen display information are stored in the cache memory of the computer. It is also understood that other temporary memory devices or even permanent memory devices are also applicable to store the unit block information and the screen display information.

According to the present invention, blocks contained inside a circulating block are treated as unit blocks. In some applications, it is possible to find multi-layered blocks in a screen display. Layers of circulated blocks to be treated as unit blocks may be limited to a certain number, such as 2 or 3 layers. Decision of the number, however, is subject to trading-off factors in designing the screen sharing system.

In some applications, the background may be a unit block with relatively large area. It is then necessary to provide a function such that a portion of the background unit block may be redrawn by defining its starting point (upper-left corner) and size.

As the present invention has been shown and described with reference to preferred embodiments thereof, those skilled in the art will recognize that the above and other changes may be made therein without departing form the spirit and scope of the invention.

What is claimed is:

1. A method for transmitting updates to a screen display, comprising:
a. dividing a previous screen display into unit blocks circulated by rigid lines and storing identities and screen display of the resulted unit blocks in a local memory;
b. transmitting identities and screen display of said unit blocks to a remote equipment and store said identities and screen display of said unit blocks in a memory of said remote equipment;
c. comparing a screen display to be displayed with a screen display previously transmitted to said remote equipment to obtain difference thereof;
d. dividing said differences into unit blocks circulated by rigid lines;
e. allocating unit blocks previously stored in said local memory that contain screen display identical to that of any unit block of said differences,
f. storing unit blocks of said differences for which no identical unit blocks are allocated in said memory and screen display of said unit blocks in said local memory;
g. transmitting identities representing unit blocks in said memory with screen display identical to that of unit blocks of said differences to said remote equipment;
h. transmitting to said remote equipment identities and screen display of unit blocks of said difference for which no unit blocks with identical screen display are allocated in said local memory; and
i. storing identities and screen display of unit blocks transmitted in step h. in said memory of said remote equipment.

2. The method according to claim 1 wherein identity of a unit block comprises size and position of said unit block on a screen.

3. The method according to claim 2 wherein identity of said unit block further comprises an identity code.

4. The method according to claim 1 wherein a block circulated by another block, both circulated by rigid lines, is divided from said other block and treated as a unit block.

5. The method according to claim 1 wherein a unit block of said differences with partially identical screen display to a unit block previously stored in said local memory is considered a unit block with screen display identical to said previously stored unit block.

6. The method according to claim 5 wherein identity of a unit block comprises size and position of said unit block on a screen.

7. The method according to claim 6 wherein identity of said unit block further comprises an identity code.

8. The method according to claim 5 wherein a block circulated by another block, both circulated by rigid lines, is divided from said other block and treated as a unit block.
